(19) United States
(12) Patent Application Publication
(10) Pub. No.: US 2018/0270743 A1
(43) Pub. Date: Sep. 20, 2018

(54) SYSTEMS AND METHODS FOR INDICATION OF SLICE TO THE TRANSPORT NETWORK LAYER (TNL) FOR INTER RADIO ACCESS NETWORK (RAN) COMMUNICATION

(71) Applicants: Aaron James CALLARD, Ottawa (CA); Philippe LEROUX, Ottawa (CA)

(72) Inventors: Aaron James CALLARD, Ottawa (CA); Philippe LEROUX, Ottawa (CA)

(73) Assignee: Huawei Technologies Co., Ltd., Shenzhen (CN)

(21) Appl. No.: 15/916,783

(22) Filed: Mar. 9, 2018

Related U.S. Application Data
(60) Provisional application No. 62/472,326, filed on Mar. 16, 2017.

(51) Int. Cl. H04W 48/18; H04W 4/08; H04L 12/24; H04W 36/26

(52) U.S. Cl. CPC H04W 48/18; H04W 36/26; H04L 41/0806; H04W 4/08

(57) ABSTRACT

Methods for configuring user plane functions associated with a network slice. The methods include: creating a mapping between a network slice instance and a respective TNL marker; selecting the network slice in response to a service request; identifying the respective TNL marker based on the mapping and the selected network slice; and communicating the identified TNL marker to a control plane function.

### CROSS-REFERENCE TO RELATED APPLICATIONS

This application is based on, and claims benefit of, U.S. Provisional Patent Application No. 62/472,326 entitled Systems And Methods For Indication Of Slice To The Transport Network Layer (TNL) For Inter Radio Access Network (RAN) Communication, filed Mar. 16, 2017, the entire content of which is hereby incorporated herein by reference.

### FIELD OF THE INVENTION

The present invention pertains to the field of communication networks, and in particular to systems and methods for Indication of Slice to the Transport Network Layer (TNL) for inter Radio Access Network (RAN) communication.

### BACKGROUND

The architecture of a Long Term Evolution (LTE) mobile network, and the corresponding Evolved Packet Core (EPC), was not initially designed to take into account the differentiated handling of traffic associated with different services through different types of access networks. Multiple data streams requiring different treatment when being sent between a User Equipment (UE) and a network access point such as an eNodeB (eNB), can be supported by configuration of one or more levels within the LTE air interface user plane (UP) stack, which consists of Packet Data Convergence Protocol (PDCP), Radio Link Control (RLC) and Medium Access Control (MAC) layers. Additionally, support for prioritization of logical channels such as the Data Radio Bearer (DRB), also referred to as Logical Channel Prioritization (LCP), is somewhat limited in its flexibility. The LTE air interface defines a fixed numerology that was designed to provide a best result for a scenario that was deemed to be representative of an expected average usage scenario. The ability of a network to support multiple network slices with respect to the differentiated treatment of traffic and the support of customised Service Level Agreements (SLAs) would allow greater flexibility. Discussions for next generation mobile networks, so-called fifth generation (5G) networks, have begun with an understanding that network slices should be supported in future network designs. Specifically, the Core Network (CN) of a 5G network is expected to expand the capabilities of the EPC through the use of network slicing to concurrently handle traffic received through or destined for multiple access networks where each access network (AN) may support one or more access technologies (ATs).

Improved techniques enabling differentiated handling of traffic associated with different services would be highly desirable.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide systems and methods for Indication of Slice to the Transport Network Layer (TNL) for inter Radio Access Network (RAN) communication.

Accordingly, an aspect of the present invention provides a control plane entity of an access network connected to a core network, the control plane entity being configured to: receive, from a core network control plane function, information identifying a selected TNL marker, the selected TNL marker being indicative of a network slice in the core network; and establish a connection using the selected TNL marker.

A further aspect of the present invention provides a control plane entity of a core network connected to an access network, the control plane entity configured to: store information identifying, for each one of at least two network slices, a respective TNL marker; select, responsive to a service request associated with one network slice, the information identifying the respective TNL marker; and forwarding, to an access network control plane function, the selected information identifying the respective TNL marker.

### BRIEF DESCRIPTION OF THE FIGURES

Further features and advantages of the present invention will become apparent from the following detailed description, taken in combination with the appended drawings, in which:

FIG. 1 is a block diagram of a computing system that may be used for implementing devices and methods in accordance with representative embodiments of the present invention;

FIG. 2 is a block diagram schematically illustrating an architecture of a representative network in which embodiments of the present invention may be deployed;

FIG. 3 is a block diagram schematically illustrating an architecture of a representative server usable in embodiments of the present invention;

FIG. 4 is a message flow diagram illustrating an example method for establishing a network slice in a representative embodiment of the present invention;

FIG. 5 is a message flow diagram illustrating an example process for establishing a PDU session in a representative embodiment of the present invention.

It will be noted that throughout the appended drawings, like features are identified by like reference numerals.

### DETAILED DESCRIPTION

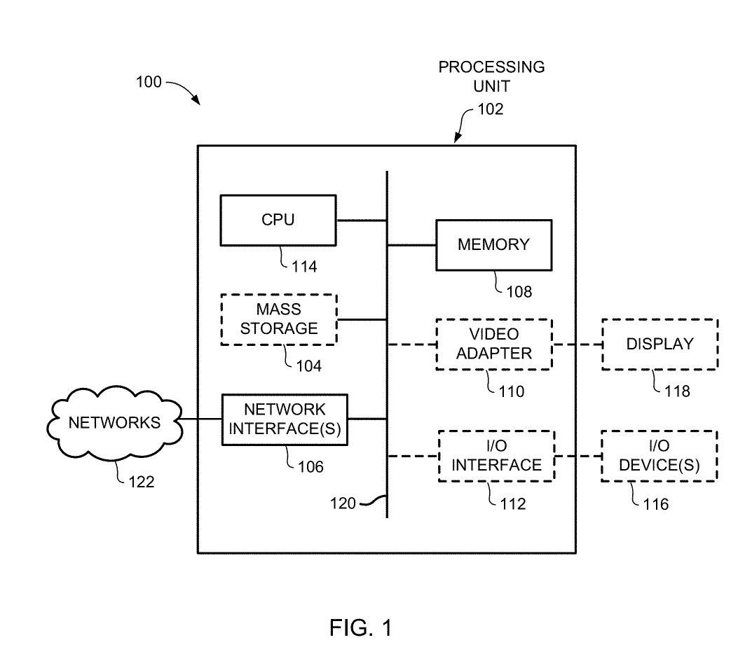

FIG. 1 is a block diagram of a computing system 100 that may be used for implementing the devices and methods disclosed herein. Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 100 includes a processing unit 102. The processing unit 102 typically includes processor such as a central processing unit (CPU) 114, a bus 120 and a memory 108, and may optionally also include elements such as a mass storage device 104, a video adapter 110, and an I/O interface 112(shown in dashed lines).

The CPU 114 may comprise any type of electronic data processor. The memory 108 may comprise any type of non-transitory system memory such as static random access memory (SRAM), dynamic random access memory (DRAM), synchronous DRAM (SDRAM), read-only memory (ROM), or a combination thereof. In an embodiment, the memory 108 may include ROM for use at boot-up, and DRAM for program and data storage for use while executing programs. The bus 120 may be one or more of any type of several bus architectures including a memory bus or memory controller, a peripheral bus, or a video bus.

The mass storage 104 may comprise any type of non-transitory storage device configured to store data, programs, and other information and to make the data, programs, and other information accessible via the bus 120. The mass storage 104 may comprise, for example, one or more of a solid state drive, hard disk drive, a magnetic disk drive, or an optical disk drive.

The optional video adapter 110 and the I/O interface 112 provide interfaces to couple external input and output devices to the processing unit 102. Examples of input and output devices include a display 118 coupled to the video adapter 110 and an I/O device 116 such as a touch-screen coupled to the I/O interface 112. Other devices may be coupled to the processing unit 102, and additional or fewer interfaces may be utilized. For example, a serial interface such as Universal Serial Bus (USB) (not shown) may be used to provide an interface for an external device.

The processing unit 102 may also include one or more network interfaces 106, which may comprise wired links, such as an Ethernet cable, and/or wireless links to access one or more networks 122. The network interfaces 106 allow the processing unit 102 to communicate with remote entities via the networks 122. For example, the network interfaces 106 may provide wireless communication via one or more transmitters/transmit antennas and one or more receivers/receive antennas. In an embodiment, the processing unit 102 is coupled to a local-area network or a wide-area network for data processing and communications with remote devices, such as other processing units, the Internet, or remote storage facilities.

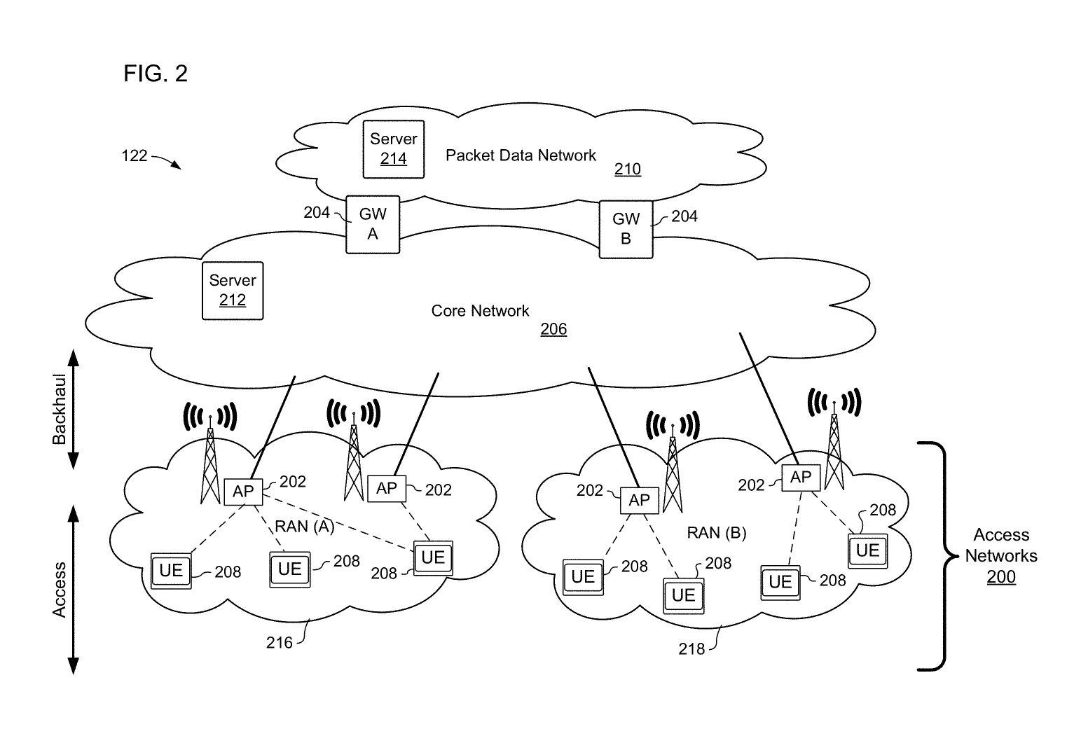

FIG. 2 is a block diagram schematically illustrating an architecture of a representative network in which embodiments of the present invention may be deployed. The network 122 may be a Public Land Mobile Network (PLMN) comprising a Radio Access Network 200 and a core network 206 through which UEs may access a packet data network (PDN) 210 (e.g. the Internet). The PLMN 122 may be configured to provide connectivity between User Equipment (UE) 208 such as mobile communication devices, and services instantiated by one or more servers such as server 212 in the core network 206 and server 214 in the packet data network 210 respectively. Thus, network 122 may enable end-to-end communications services between UEs 208 and servers 212 and 214, for example.

As may be seen in FIG. 2, the AN 200 may implement one or more access technologies (ATs), and in such a case will typically implement one or more radio access technologies, and operate in accordance with one or more communications protocols. Example access technologies that may be implemented include Radio Access Technologies (RATs) such as, Long Term Evolution (LTE), High Speed Packet Access (HSPA), Global System for Mobile communication (GSM), Enhanced Data rates for GSM Evolution (EDGE), 802.11 WiFi, 802.16 WiMAX, Bluetooth and RATs based on New Radio (NR) technologies, such as those under development for future standards (e.g. so-called fifth generation (5G) NR technologies); and wireline access technologies such as Ethernet. By way of example only, the Access Network 200 of FIG. 2 includes two Radio Access Network (RAN) domains 216 and 218, each of which may implement multiple different RATs. In each of these access networks, one or more Access Points (APs) 202, also referred to as Access Nodes, may be connected to at least one Packet Data Network Gateway (GW) 204 through the core network 206.

In the LTE standards, as defined by the Third Generation Partnership Project (3GPP), an AP 202 may also be referred to as an evolved Node-B (eNodeB, or eNB), while in the context of discussion of a next generation (e.g. 5G) communications standard, an AP 202 may also be referred to by other terms such as a gNB. In this disclosure, the terms Access Point (AP), access node, evolved Node-B (eNB), eNodeB and gNB, will be treated as being synonymous, and may be used interchangeably. In the LTE standards, eNBs may communicate with each other via defined interfaces such as the X2 interface, and with nodes in the core network 206 and data packet network 210 via defined interfaces such as the S1 interface. In an Evolved Packet Core (EPC) network, the gateway 204 may be a packet gateway (PGW), and in some embodiments one of the gateways 204 could be a serving gateway (SGW). In a 5G CN, one of the gateways 204 may be a user plane gateway (UPGW).

In an access network implementing a RAT, the APs 202 typically include radio transceiver equipment for establishing and maintaining wireless connections with the UEs 208, and one or more interfaces for transmitting data or signalling to the core network 206. Some traffic may be directed through CN 206 to one of the GWs 204 so that it can be transmitted to a node within PDN 210. Each GW 204 provides a link between the core network 206 and the packet data network 210, and so enables traffic flows between the packet data network 210 and UEs 208. It is common to refer to the links between the APs 202 and the core network 206 as the “backhaul” network which may be composed of both wired and wireless links.

Typically, traffic flows to and from UEs 208 are associated with specific services of the core network 206 and/or the packet data network 210. As is known in the art, a service of the packet data network 210 will typically involve either one or both of a downlink traffic flow from one or more servers 214 in the packet data network 210 to a UE 208 via one or more of the GWs 204, and an uplink traffic flow from the UE 208 to one or more of the servers in the packet data network 210, via one or more of the GWs 204. Similarly, a service of the core network 206 will involve either one or more of a downlink traffic flow from one or more servers 212 of the core network 206 to a UE 208, and an uplink traffic flow from the UE 208 to one or more the servers 212. In both cases, uplink and downlink traffic flows are conveyed through a data bearer between the UE 208 and one or more host APs 202. The resultant traffic flows can be transmitted, possibly with the use of encapsulation headers (or through the use of a logical link such as a core bearer) through the core network 206 from the host APs 202 to the involved GWs 204 or servers 212 of the core network 206. An uplink or downlink traffic flow may also be conveyed through one or more user plane functions (UPFs) 230 in the core network 206.

In radio access networks 216-218, the data bearer comprises a radio link between a specific UE 208 and its host AP(s) 202, and is commonly referred to as a Data Radio Bearer (DRB). For convenience of the present description, the term Data Radio Bearer (DRB) shall be used herein to refer to the logical link(s) between a UE 208 and its host AP(s) 202, regardless of the actual access technology implemented by the access network in question.

In Evolved Packet Core (EPC) networks, the core bearer is commonly referred to as an EPC bearer. In future revisions to the EPC network architecture, a Protocol Data Unit (PDU) session may be used to encapsulate functionality similar to an EPC bearer. Accordingly, the term “core bearer” will be used in this disclosure to describe the connection(s) and or PDU sessions set up through the core network 206 to support traffic flows between APs 202 and GWs 204 or servers 212. A network slice instance (NSI) can be associated with a network service (based on its target subscribers, bandwidth, Quality of Service (QoS) and latency requirements, for example) and one or more PDU sessions can be established within the NSI to convey traffic associated with that service through the NSI using the appropriate core bearer. In a core network 206 that supports network slicing, one or more core bearers can be established in each NSI.

For the purposes of embodiments discussed within this disclosure, the term Transport Network Layer (TNL) may be understood to refer to the layer(s) under the IP layer of the LTE Evolved UMTS Terrestrial Radio Access Network (E-UTRAN) user plane protocol stack, and its equivalents in other protocols. In the E-UTRAN, the TNL encompasses: Radio Resources Control (RRC); Packet Data Convergence Protocol (PDCP); Radio Link Control (RLC); and Medium Access Control (MAC), as well as the physical data transport. As such, the TNL may encompass data transport functionality of the core network 206, the data packet network 210 and RANs 216-218. The TNL is responsible for transport of a PDU from one 3GPP logical entity to another (gNB, AMF). In RATs such as LTE and 5G NG RAT the TNL can be an IP transport layer. Other options are possible. Other protocol stack architectures, such as Open System Interconnection (OSI) use different layering, and different protocols in each layer. However, in each case there are one or more layers that are responsible for the transport of packets between nodes (such as, for examples layers 1-4 of the 7-layer OSI model), and so these would also be considered to fall within the intended scope of the Transport Network Layer (TNL).

For the purposes of this disclosure, a network “slice” (in one or both of the Core Network or the RAN) is defined as a collection of one or more core bearers (or PDU sessions) which are grouped together for some arbitrary purpose. This collection may be based on any suitable criteria such as, for example, business aspects (e.g. customers of a specific Mobile Virtual Network Operator (MVNO)), Quality of Service (QoS) requirements (e.g. latency, minimum data rate, prioritization etc.); traffic parameters (e.g. Mobile Broadband (MBB), Machine Type Communication (MTC) etc.), or use case (e.g. machine-to-machine communication; Internet of Things (IoT), etc.).

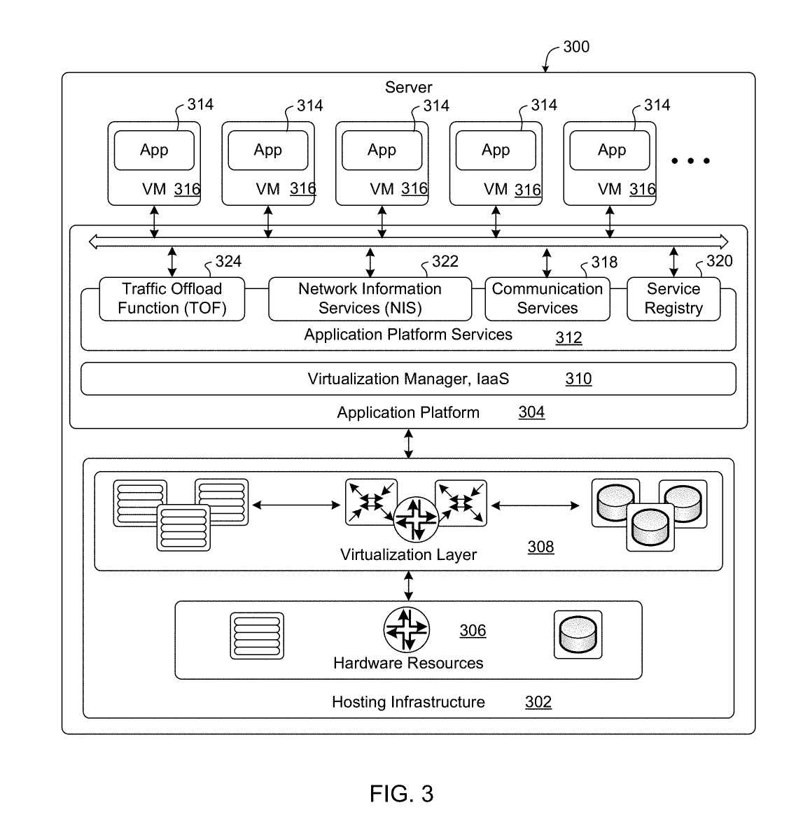

FIG. 3 is a block diagram schematically illustrating an architecture of a representative server 300 usable in embodiments of the present invention. It is contemplated that any or all of the APs 202, gateways 204 and servers 212, 214 of FIG. 2 may be implemented using the server architecture illustrated in FIG. 3. It is further contemplated that the server 300 may be physically implemented as one or more computers, storage devices and routers (any or all of which may be constructed in accordance with the system 100 described above with reference to FIG. 1) interconnected together to form a local network or cluster, and executing suitable software to perform its intended functions. Those of ordinary skill will recognize that there are many suitable combinations of hardware and software that may be used for the purposes of the present invention, which are either known in the art or may be developed in the future. For this reason, a figure showing the physical server hardware is not included in this specification. Rather, the block diagram of FIG. 3 shows a representative functional architecture of a server 300, it being understood that this functional architecture may be implemented using any suitable combination of hardware and software.

As may be seen in FIG. 3, the illustrated server 300 generally comprises a hosting infrastructure 302 and an application platform 304. The hosting infrastructure 302 comprises the physical hardware resources 306 (such as, for example, information processing, traffic forwarding and data storage resources) of the server 300, and a virtualization layer 308 that presents an abstraction of the hardware resources 306 to the Application Platform 304. The specific details of this abstraction will depend on the requirements of the applications being hosted by the Application layer (described below). Thus, for example, an application that provides traffic forwarding functions may be presented with an abstraction of the hardware resources 306 that simplifies the implementation of traffic forwarding policies in one or more routers. Similarly, an application that provides data storage functions may be presented with an abstraction of the hardware resources 206 that facilitates the storage and retrieval of data (for example using Lightweight Directory Access Protocol—LDAP).

The application platform 304 provides the capabilities for hosting applications and includes a virtualization manager 310 and application platform services 312. The virtualization manager 310 supports a flexible and efficient multi-tenancy run-time and hosting environment for applications 314 by providing Infrastructure as a Service (IaaS) facilities. In operation, the virtualization manager 310 may provide a security and resource “sandbox” for each application being hosted by the platform 304. Each “sandbox” may be implemented as a Virtual Machine (VM) image 316 that may include an appropriate operating system and controlled access to (virtualized) hardware resources 306 of the server 300. The application-platform services 312 provide a set of middleware application services and infrastructure services to the applications 314 hosted on the application platform 304, as will be described in greater detail below.

Applications 314 from vendors, service providers, and third-parties may be deployed and executed within a respective Virtual Machine 316. For example, Network Functions Virtualization (NFV) Management and Organization (MANO) and Service-Oriented Virtual Network Auto-Creation (SONAC) and its various functions such as Software Defined Topology (SDT), Software Defined Protocol (SDP), and Software Defined Resource Allocation (SDRA) may be implemented by means of one or more applications 314 hosted on the application platform 304 as described above. Communication between applications 314 and services in the server 300 may be designed according to the principles of Service-Oriented Architecture (SOA) known in the art. Those skilled in the art will appreciate that in place of virtual machines, virtualization containers may be employed to reduce the overhead associated with the instantiation of the VM. Containers and other such network virtualization techniques and tools can be employed along with other such variations as would be required if a VM is not instantiated.

Communication services 318 may allow applications 314 hosted on a single server 300 (or a cluster of servers) to communicate with the application-platform services 312 (through pre-defined Application Programming Interfaces (APIs) for example) and with each other (for example through a service-specific API).

A Service registry 320 may provide visibility of the services available on the server 200. In addition, the service registry 320 may present service availability (e.g. status of the service) together with the related interfaces and versions. This may be used by applications 414 to discover and locate the end-points for the services they require, and to publish their own service end-point for other applications to use.

Mobile-edge Computing allows cloud application services to be hosted alongside mobile network elements, and also facilitates leveraging of the available real-time network and radio information. Network Information Services (NIS) 322 may provide applications 314 with low-level network information. For example, the information provided by MS 322 may be used by an application 314 to calculate and present high-level and meaningful data such as: cell-ID, location of the subscriber, cell load and throughput guidance.

A Traffic Off-Load Function (TOF) service 324 may prioritize traffic, and route selected, policy-based, user-data streams to and from applications 214. The TOF service 3424 may be supplied to applications 314 in various ways, including: A Pass-through mode where (uplink and/or downlink) traffic is passed to an application 314 which can monitor, modify or shape it and then send it back to the original Packet Data Network (PDN) connection (e.g. 3GPP bearer); and an End-point mode where the traffic is terminated by the application 314 which acts as a server.

As is known in the art, conventional access networks, including LTE, were not originally designed to take advantage of network slicing at an architectural level. While much attention has been directed to the use of network slicing in the core network 206, slicing of a Radio Access Network, such as RAN 216 or 218, has drawn less immediate attention. Support for network slicing in a Radio Access Network requires a technique by which the core network 206 (or, more generally, the Transport Network Layer (TNL)) can notify the APs 202 of the NSI associated with a specific core bearer or PDU session. A difficulty with such an operation is that current access network designs (for example LTE and its successors) do not provide any techniques by which APs can exchange information with the TNL. For example, the only way that an AP 202 can infer the state of TNL links is by detecting lost packets or similar user plane techniques such as Explicit Congestion Notification (ECN) bits. Similarly, the only way that the TNL may be able to provide slice prioritization is through user plane solutions such as packet prioritization, ECN or the like. However, the TNL can only do this if the traffic related to one ‘slice’ is distinguishable from traffic related to another ‘slice’ at the level of the TNL.

Embodiments of the present invention provide techniques for supporting network slicing in the user plane of core and access networks.

In accordance with embodiments the present invention, a configuration management function (CMF) may assign one or more TNL markers, and define a mapping between each TNL marker and a respective network slice instance. Information of the assigned TNL markers, and their mapping to network slice instances may be passed to a Core Network Control Plane Function (CN CPF) or stored by the CMF in a manner that is accessible by the CN CPF. In some embodiments, each network slice instance (NSI) may be identified by an explicit slice identifier (Slice ID). In such cases, a mapping can be defined between each TNL marker and the Slice ID of the respective network slice instance, so that the appropriate TNL marker for a new service instance (or PDU session) may be identified from the Slice ID. In other embodiments, each slice instance may be distinguished by a specific combination of performance parameters (such as QoS, Latency etc.), rather than an explicit Slice ID. In such cases, the mapping may be defined between predetermined combinations of performance parameters and TNL markers, so that the appropriate TNL marker for a new service instance (or PDU session) may be identified from the performance requirements of the new service instance.

Examples of the CN CPF include a Mobility Management Entity (MME), an Access and Mobility Function (AMF), a Session Management Function (SMF) or other logical control node in the 3GPP architecture.

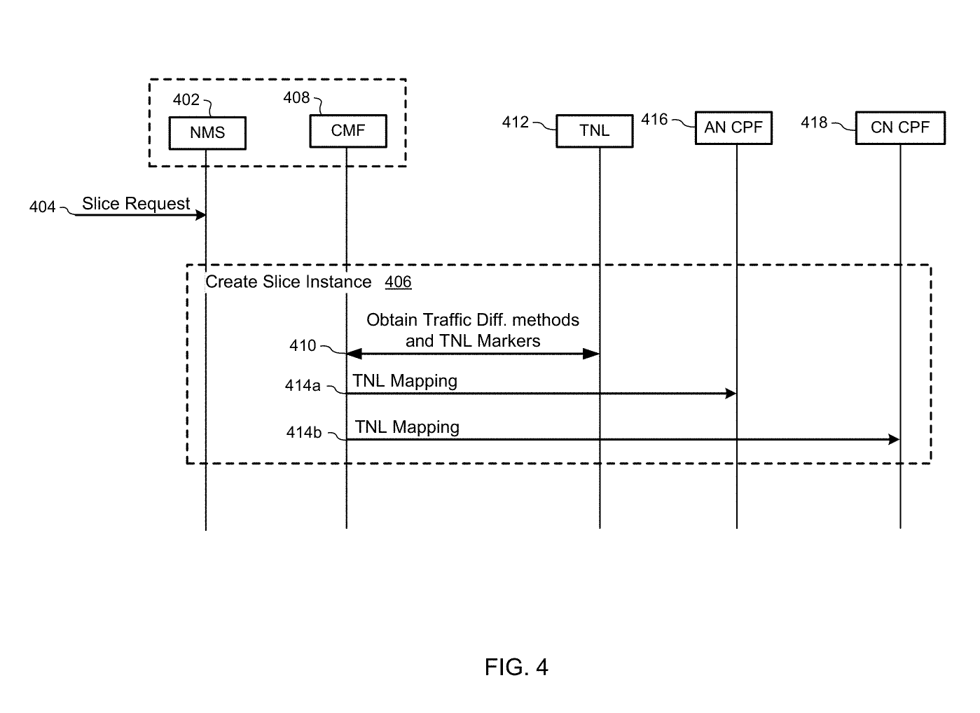

FIG. 4 is a flow diagram illustrating an example process for creating a network slice, which may be used in embodiments of the present invention.

Referring to FIG. 4, the example begins when the network management system (NMS) 402 receives a request (at 404) to provide a network slice instance (NSI). In response to the received request, the network management system will interact with the appropriate network management entities managing resources required to create (at 406) the network slice instance using methods known in the art for example. For this purpose, the CMF 408 may interact (at 410) with the TNL 412 to obtain TNL maker information associated with the new slice. In some embodiments, the TNL marker information obtained by the CMF 408 may include respective traffic differentiation methods and associated TNL markers for different network segments where transport is used.

Next, the CMF 408 may configure (at 414a and 414b) the AN CPF 416 and the CN CPF 418 with mapping information to enable the AN CPF 416 and the CN CPF 418 to map the TNL markers to the slice. The CMF 408 may also inform the AN CPF 416 how to include TNL information in data packets associated with the slice. Similarly, it is understood that the CMF 408 may also inform the TNL, RAN and PDN management systems of the applicable mapping information. Once all the components are configured including the TNL, the slice creation is complete and the customer will be informed of the completion of the network slice instance to use it for the end user traffic associated with one or more PDU sessions.

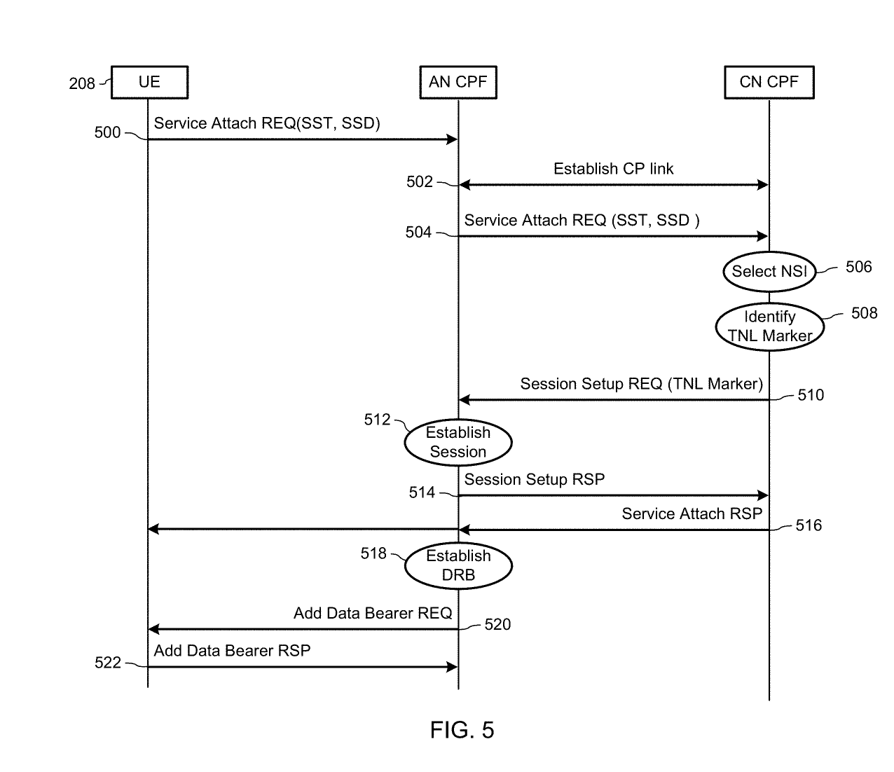

When a new service instance is requested (e.g. by a gNB), the CN CPF can identify the appropriate network slice for the service instance, and use the mapping to identify the appropriate TNL marker to be used by the gNB. The CN CPF can then provide both the service parameters and the identified TNL marker for the service instance to the Access Network Control Plane Function (AN CPF). Based on this information, the AN CPF can configure the gNB to route traffic associated with the service instance using the identified TNL marker. At the same time, the CN CPF can configure nodes of the CN to route traffic associated with the new service instance to and from the gNB using the selected TNL marker. This arrangement can allow for the involved gNB to forward traffic through the appropriate CN slice without having explicit information of the CN slice configuration. Consequently, the techniques disclosed herein may be implemented by any given access network 200 and core network 206 with very limited revisions in the protocols or technologies implemented in those networks. FIG. 5 is a flow diagram illustrating an example process for establishing a PDU session.

It may be appreciated that the identified TNL marker facilitates traffic forwarding between the gNB 202 and the CN 206. Similarly, those skilled in the art will appreciate that traffic forwarding within the CN 206, within the AN 200, or between the CN 206 and the PDN 210 nodes may also use a TNL marker associated with the NSI when forwarding traffic or differentiating traffic in those network segments. Further it will be appreciated that such TNL marker can be the same TNL marker that is used for traffic forwarding between the AN 200 and the CN 206. Alternatively, a different TNL marker (which may be associated with either the TNL marker of the AN 200 or the service instance) can be used for traffic forwarding within the CN 206, within the AN 200 (e.g. between APs 202), or between the CN 206 and the PDN 210. In such cases, the CMF may provide the applicable TNL marker information to the respective control plane functions (or management systems, as applicable) in a manner similar to that described above for providing TNL marker information to the AN CPF.

Examples of an AN CPF are a gNB, eNB, LTE WLAN Radio Level Integration with IP sec Tunnel-Secure Gateway (LWIP-SeGW), WLAN termination point (WT).

Referring to FIG. 5, the example process begins when a UE 208 sends a Service Attachment Request message (at step 500) to request a communication service. The Service Attach Request message may include information defining a requested service/slice type (SST) and a service/slice differentiator (SSD). The AN CPF establishes a control plane link (at 502) with the CN CPF, if necessary, and forwards (at 504) the Service Attachment Request message to the CN-CPF, along with information identifying the UE. The establishment of CP link in 402 may be obviated by the use of an earlier established link. The CN CPF can use the received SST and SSD information in combination with other information (such as, for example, the subscriber profile associated with the UE, the location of the UE, the network topology etc.) available to the CN CPF to select (at 506) an NSI to provide the requested service to the UE 208. The CN CPF can then use the selected NSI in combination with the location of the UE 208 (that is, the identity of an AP 202 hosting the UE 208) to identify (at 508) the appropriate TNL Marker.

Following selection of the NSI and/or TNL Marker, the CN CPF sends (at 510) a Session Setup Request to the AN CPF that includes UE-specific session configuration information, and the TNL Marker associated with the selected NSI. In response to the Session Setup Request, the AN CPF establishes (at 512) a new session associated with the requested service, and use the TNL marker to configure the AP 202 to send and receive PDUs associated with the session through the core network or within the RAN using the selected TNL marker.

The AN CPF may then send a Session Setup Response (at 514) to the CN CPF that includes success (or failure) of session admission control. The CN CPF then may send a Service Attachment Response (at 516) to the UE (via the AN CPF) that includes session configuration information. Using the session configuration information, the AN CPF may configure one or more DRBs (at 518) to be used between the AP 202 and the UE 208 to carry the subscriber traffic associated with the service. Once the configuration of the DRB has been determined, the AN CPF may send (at 520) an Add Data Bearer Request to the UE containing the configuration of the DRB(s). The UE may then send an Add Data Bearer Response to the AN CPF (at 522) to complete the service session setup process.

As may be appreciated, the AN CPF may be implemented by way of one or more applications executing on the gNB (s) of an access network 200, or a centralised server (not shown) associated with the access network 200. In some embodiments, the AP may be implemented as a set of network functions instantiated upon computing resources within a data center, and provided with links to the physical transmit resources (e.g. antennae). The AN CPF may be implemented as a virtual function instantiated upon the same data center resources as the AP or another such network entity. Similarly, the CN CPF may be implemented by way of one or more applications executing on the GW(s) 204 of the core network 206, or a centralised server (for example server 212) of the core network 206. It will be appreciated that for this purpose the gNB(s) and/or centralized servers may be configured as described above with reference to FIG. 3. Similarly, the CMF may be implemented by way of one or more applications executing on the gNB(s) of an access network 200, or a centralised server (not shown) associated with the access network 200 or with the core network 206. Optionally, respective different CMFs may be implemented in the core network 206 and an access network 200, and configured to exchange information (for example regarding the identified TNL and mapping) by means of suitable signaling in a manner known in the art. In this case each of the CN-CPF and the AN-CPF may obtain the selected TNL for a given service instance or PDU session from their respective CMF.

In general, a TNL marker may be any suitable parameter or combination of parameters that is(are) accessible by both the TNL and a gNB. It is contemplated that parameters usable as TNL markers may be broadly categorized as: network addresses; Layer 2 header information; and upper layer header parameters. If desired, TNL markers assigned to a specific gNB may be constructed from a combination of parameters selected from more than one of these categories. However, for simplicity of description, each category will be separately described below.

### Network Addresses

Network addresses are considered to be the conceptually simplest category of parameters usable as TNL markers. In general terms, each TNL marker assigned to a given gNB is selected from a suitable address space of the Core Network. For example, in a Core Network configured to use Internet Protocol, each assigned TNL marker may be an IP address of a node or port within the Core Network. Alternatively, in a Core Network configured to use Ethernet, each assigned TNL marker may be a Media Access Control (MAC) address of a node within the Core Network. For gNBs that implement the Xn interface (either in Xn-U or Xn-C), IP addresses are preferably used as the TNL markers. For communication that does not correspond to any particular traffic (e.g. mobility, Self-Organizing Network (SON) etc) a default ‘RAN slice’ may be defined in the Core Network and mapped to appropriate TNL markers (e.g. network addresses) assigned to gNBs.

The use of Network Addresses as TNL markers has the effect of “multi-homing” each gNB in the network, with each TNL marker (network address) being associated via the mapping with a respective network slice defined in the Core Network. When a new service instance is requested (e.g. by a UE), the CN CPF can identify the appropriate network slice for the service instance, and use the mapping to identify the appropriate TNL marker (network address) to be used by the gNB for traffic associated with the new service instance. Alternatively, the CN CPF may use required performance parameters of the new service instance to identify the appropriate TNL marker (network address) to be used by the gNB for traffic associated with the new service instance. The CN CPF can then provide both the service parameters and the identified TNL marker (network address) for the service instance to the Access Network Control Plane Function (AN CPF). In some embodiments, the CN CPF may “push” the identified TNL marker to the AN CPF. In other embodiments, the AN CPF may request the TNL marker associated with an identified network slice or service instance. In other embodiments the association between identified network slices may be made known to the AN CPF through management signaling. In still other embodiments the mapping of service instance to TNL markers may be a defined function specified in a standard.

Based on the TNL marker information, the AN CPF can configure the gNB to process traffic associated with the new service instance using the appropriate TNL marker (network address). At the same time, the CN CPF can configure nodes of the CN to route traffic associated with the new service instance to and from the gNB using the selected TNL marker (network address). This arrangement can allow for the involved gNB to forward traffic through the appropriate TNL slice instance without having explicit information of the TNL slice configuration.

### Layer 2 Header Information

Layer 2 header information can also be used, either alone or in combination with network addresses, to define TNL markers. Examples of Layer 2 header information that may be used for this purpose include Virtual Local Area Network (VLAN) tags/identifiers and Multi-Protocol Label Switching (MPLS) labels. It is contemplated that other layer 2 header information currently exists or may be developed in the future and may also be used (either alone or in combination with network addresses) to define TNL markers.

As may be appreciated, the use of network addresses (alone) as TNL markers suffers a limitation in that a 1:1 mapping between the TNL marker and a specific network slice can only be defined within a single network address space. The use of Layer 2 header information to define TNL markers enables the definition of a 1:1 mapping between a given TNL marker and a specific network slice that spans multiple core networks or core network domains with different (possibly overlapping) address spaces.

### Upper Layer Header Parameters

The use of upper layer header parameters may be considered as an extension of the use of Layer 2 header information. In the case of Upper Layer header parameters, header fields normally used in upper layer (e.g. layer 3 and higher, transport (UDP/TCP), tunneling (GRE, GTP-U, Virtual Extensible LAN (VXLAN), Generic Network Virtualization Encapsulation (GENEVE), Network Virtualization using Generic Routing Encapsulation (NVGRE), Stateless Transport Tunneling (STT) applications layer etc.) packet headers may be used, either alone or in combination with network addresses and/or Layer 2 header information) to define TNL markers. Examples of upper layer header parameters that may be used for this purpose include: source ports identifiers, destination ports identifiers, Tunnel Endpoint Identifiers (TEIDs), and PDU session identifiers. Example upper layer headers from which these parameters may be obtained include: User Datagram Protocol (UDP), Transfer Control Protocol (TCP), GPRS Tunneling Protocol-User Plane (GTP-U) and General Routing Encapsulation (GRE). Other upper layer headers may also be used, as desired.

For example, the source port identifiers in the UDP component of GTP-U can be mapped from the slice ID. When transmitting data over an interface (such as Xn, Xw, X2, etc), the appropriate source port identifier may be identified based on the slice ID associated with the encapsulated traffic associated with the PDU session. The source port identifiers may be partitioned into multiple sets, which correspond to different slice IDs. In simple embodiments, a set of least significant bits of the source port identifiers may be mapped directly to the slice ID.

In some embodiments, respective mappings can be defined to associate predetermined combinations of upper layer header parameter values to specific network slices. This arrangement is beneficial in that it enables a common mapping to be used by all of the gNBs connected to the core network, as contrasted with a mapping between IP Addresses (for example) and network slices, which may be unique to each gNB.

As may be appreciated, mappings between TNL markers and respective network slice instances can be defined in multiple ways. In the following paragraphs, alternative mapping techniques are described. These techniques can be broadly categorised as: Direct PDU session association, or Implicit PDU session association.

In many scenarios, there may be significant freedom in the choice of TNL marker. For example, in an embodiment in which network or port address is directly mapped to the slice identifier, a large number of addresses may be available for use representing a given Slice ID with different TNL markers. In such cases, the selection of the specific addresses to be used as TNL markers would be a matter of implementation choice.

The simplest mapping is a direct (or explicit) association between a PDU session and a slice identifier. In this scenario, PDU sessions are explicitly assigned a slice identifier. This slice identifier is then associated with one or more respective TNL markers. Any traffic associated with a given PDU session then uses one of the TNL markers associated with the assigned slice identifier. Information about the mapping from slice identifier to TNL markers may be passed to the gNB. This could be through and one or more of; management plane signalling; dynamic lookups such as database queries or the like; or through direct control plane signalling from the CN CPF. DNS like solutions are envisioned.

An alternative mapping is a direct parameter association in which a PDU session is associated with parameters to be used for that PDU session. In this scenario, the gNB is configured to use a particular TNL marker on a per PDU session basis. This refers to all interfaces regarding the PDU session, including NG-U, Xn, X2, Xw and others. For example, the gNB IP address to be used for a given PDU session may be configured as part of an overall NG-U configuration process. In the following paragraphs, various parameter association techniques are discussed. These parameters sets may be a range of a particular parameter such as an IP address subnet, a wildcard mask, or a combination of two or more parameters.

One example parameter association technique may be described as Reachability-based parameter configuration. In this technique, an gNB may be provisioned with multiple TNL interfaces, which may be different IP addresses or L2 networks, for example. The TNL may be configured in such a way that some but not all of the gNB's interfaces can interact with all other network functions (e.g. UPF/gNB/AMF) available in the Core Network. The gNB must therefore choose the interface which can reach the network function(s) required for a particular service instance. This choice of appropriate interface may be configured via configuration of the traffic forwarding or network reachability tables (or similar) of the gNB. Conversely the gNB may be configured to support one or more Virtual Switch components, and receive signalling through those components. In still further alternative embodiments, the gNB may determine autonomously the connectivity of the Core Network and determine the appropriate interface for each link. This may be through ping type messages sent on the different interfaces. Other options are possible.

Another example parameter association technique may be described as Reflexive Mapping. In this technique, the gNB may not receive explicit information of slice configuration or identifiers. However, the gNB may receive information describing of how to map flows received on vertical links (such as NG-U/S1) to horizontal links (such as Xn/Xw/X2) and vice versa. These mappings may be between TNL markers (such as IP fields, VLAN tags, TNL interfaces) associated with each of the vertical and horizontal links.

Reflexive Mapping may operate in accordance with a principle that the gNB should transmit data using the same TNL marker, as the TNL marker associated with the received data. In a simple case this can be described as ‘transmit data using the same parameters that the data was received with’. That is, if a PDU is received on an interface with a TNL marker defined as the combination of IP address 192.168.1.2 and source port identifier “1000”, then that same PDU should be transmitted using the same IP address and port identifier. It will be appreciated that, in this scenario, the source port identifier of the received PDU would be retained as the source port identifier in the transmitted PDU, while the destination IP address of the received PDU would be moved to the source IP address of the transmitted PDU.

In other embodiments, the mapping may be more complex and/or flexible. Such mappings may be from one TNL marker to another, for example. This operation may make use of an intermediary ‘slice ID’ or a direct mapping of the parameters. For example, in an Intermediary Mapping scenario, a given parameter set may map to a Slice ID, which in turn maps to one or more TNL markers. In this case the Slice ID represents an intermediary mapping. In contrast, in a Direct Mapping scenario, a given parameter set may map directly to one or more TNL markers.

Further example mappings are described below:

### EXAMPLE 1

Source/destination port number: Consider a scenario in which the gNB receives an NG-U GTP-U packet using a TNL marker defined as the combination of IP address 192.168.1.2 and source port 1000. If the gNB uses dual connectivity to transmit the data to the end user via a second gNB, it would forward the encapsulated PDU packet to a second gNB using the source network address 192.1968.1.3, it will set the source port to 1000

### EXAMPLE 2

IP address or range: Consider a scenario in which the gNB receives an S1/NG-U GTP-U packet using a TNL marker defined as the IP address 192.168.1.2, it will be configured to use an IP address in the range of 192.168.10.x (for example, 192.168.10.3 and 192.168.10.2 for its source address) to establish X2/Xn interface connections to its neighbour AP.

In a similar manner, the mapping could define a TEID value of GTP-U.

For example, in a “use to make” approach of TEID tunnel, the source gNB may compute a TEID value to reach a neighbour gNB taking into account the TEID it received packets on (e.g. S1/NG-U), e.g. the first X bits of the TEID are to be reused.

In a “make before use” approach of TEID tunnel, the gNB requesting an X2 interface would provide the TEID value or the first X bits of the TEID value or a hash of the TEID value to the neighbour gNB while requesting to establish the GTP-U tunnel (for it to apply reflexive TEID mapping). In turn the neighbour gNB would be able to provide a TEID that maps the initial TEID (located over the NG-U interface to master gNB). This may be done by configuring mappings at gNBs. Such mappings may specify bit fields inside the TEID that are reused and constitute a TNL marker that identifies a differentiation at the transport layer. i.e. a slice or a QoS”).

For simplicity of description, the embodiments described above utilize CN CPF and AN CPF functions that operate directly to configure elements of the CN and AN to establish a PDU session. In other embodiments, the CN CPF and AN CPF functions may make use of other entities to perform some or all of these operations.

For example, in some embodiments the CN CPF may be configured to supply a particular slice identifier for PDU sessions with appropriate parameters. How this slice identifier relates to TNL markers may be transparent to tis CN CPF. A third entity may then operate to configure the TNL with routing, prioritizations and possibly rate limitations associated with various TNL markers. The CN CPF may be able to request a change in these parameters by signaling to some other entity, when it determines that the current parameters are not sufficient to support the current sessions. This may be referred to as the creation of a virtual network, or by other means. Similarly the AN CPF may also be configured with the TNL parameters associated with particular slice identifiers. The TNL markers would thus be largely transparent to the AN CPF.

In other embodiments the CN CPF may be configured with TNL markers which it may use for traffic regarding PDU sessions belonging to a particular slice. For CN CPFs which deal with traffic for only one slice (i.e. a Service Management Function (SMF)) this mapping may not be explicitly defined to such CN CPFs. The CN CPF may then provide the TNL markers to the AN CPF for use along the various interfaces.

In yet other embodiments the CN CPF may provide TNL markers to another entity which then configures the TNL to provide the requested treatment. In some embodiments the supplied information exchanged between the CN CPF and the AN CPF, may not directly describe the TNL marker but rather reference it implicitly. Examples of this may include the Slice ID, Network Slice Selection Assistance Information (NSSAI), Configured NSSAI (C-NSSAI), Selected NSSAI (S-NSSAI), accepted NSSAI (A-NSSAI).

Based on the foregoing, it may be appreciated that elements of the present invention provide at least some of the following:
A control plane entity of an access network connected to a core network, the control plane entity being configured to:
   receive, from a core network control plane function, information identifying a selected TNL marker, the selected TNL marker being indicative of a network slice in the core network; and
   establish a connection using the selected TNL marker.
In some embodiments, the selected TNL marker comprises any one or more of:
   a network address of the core network;
   Layer 2 Header information of the core network; and
   upper layer parameters.
In some embodiments, the control plane entity comprises either one or both of at least one Access Point of the access network or a server associated with the access network.
A control plane entity of a core network connected to an access network, the control plane entity configured to:
   store information identifying, for each one of at least two network slices, a respective TNL marker;
   select, responsive to a service request associated with one network slice, the information identifying the respective TNL marker; and
   forwarding, to an access network control plane function, the selected information identifying the respective TNL marker.
In some embodiments, the control plane entity comprises any one or more of at least one gateway and at least one server of the core network.
In some embodiments, the wherein the information identifying the selected TNL marker is selected based on a Network Slice instance associated with the service request.
In some embodiments, the selected TNL marker comprises any one or more of:
   a network address of the core network;
   Layer 2 Header information of the core network; and
   upper layer performance parameters.
A method for configuring user plane functions associated with a network slice of a core network, the method comprising:
   creating a mapping between a network slice instance and a respective TNL marker;
   selecting the network slice in response to a service request;
   identifying the respective TNL marker based on the mapping and the selected network slice; and
   communicating the identified TNL marker to a control plane function.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A control plane function of an access network connected to a core network, the control plane function comprising:
at least one processor; and
a non-transitory computer readable storage medium including software instructions configured to control the at least one processor to implement steps of:
receiving, from a core network control plane function, information identifying a selected TNL marker, the selected TNL marker being indicative of a network slice in the core network; and
establishing a connection in the access network, the connection being associated with the network slice indicated by the selected TNL marker.

2. The control plane function as claimed in claim 1, wherein the selected TNL marker comprises any one or more of:
a network address of the core network;
Layer 2 Header information of the core network; and
upper layer parameters.

3. The control plane function as claimed in claim 1, wherein the control plane function comprises either one or both of at least one Access Point of the access network or a server associated with the access network.

4. A control plane function of a core network connected to an access network, the control plane function comprising:
at least one processor; and
a non-transitory computer readable storage medium including software instructions configured to control the at least one processor to implement steps of:
receiving a service attachment request from an Access Network (AN) control plane function, the service attachment request being associated with a network slice;
selecting, responsive to the received service attachment request, information identifying a respective TNL marker associated with the network slice; and
forwarding, to the access network control plane function, the selected information identifying the respective TNL marker.

5. The control plane function as claimed in claim 4, wherein the control plane function comprises any one or more of at least one gateway and at least one server of the core network.

6. The control plane function as claimed in claim 4, further comprising:
receiving, from a configuration management function of the network, information identifying a respective TNL marker for each one of at least two network slices; and
storing the received information identifying the respective TNL marker for each one of at least two network slice instances.

7. The control plane function as claimed in claim 6, wherein selecting the information identifying the respective TNL marker comprises:
selecting one network slice instance from the at least two network slice instances, based on the service attachment request; and
identifying the respective TNL marker for the selected network slice instance.

8. The control plane function as claimed in claim 4, wherein the selected TNL marker comprises any one or more of:
a network address of the core network;
Layer 2 Header information of the core network; and
upper layer performance parameters.

9. A configuration management function of a network including a core network and an access network; the configuration management function comprising:
at least one processor; and
a non-transitory computer readable storage medium including software instructions configured to control the at least one processor to implement steps of:
obtaining, from a Transport Network Layer of the network, a TNL marker for a network slice instance; and
communicating a mapping between the obtained TNL marker and the network slice instance to a control plane function of the network.

10. The configuration management function as claimed in claim 9, further comprising software instructions configured to control the at least one processor to implement one of steps of:
interacting with network management system to create or modify the network slice instance.
